(19) United States
(12) Patent Application Publication
(10) Pub. No.: US 2025/0232622 A1
(43) Pub. Date: Jul. 17, 2025

(54) ELECTRONIC DATA RECORDER (EDR) PROTECTION FOR AUTONOMOUS VEHICLES

(71) Applicant: Torc Robotics, Inc., Blacksburg, VA (US)

(72) Inventors: William Davis, Blacksburg, VA (US); Joseph R. Fox-Rabinovitz, Blacksburg, VA (US); Akshay Pai Raikar, Blacksburg, VA (US); Saurabh Bagalkar, Blacksburg, VA (US)

(21) Appl. No.: 18/410,922

(22) Filed: Jan. 11, 2024

(51) Int. Cl. G07C 5/08; B60W 60/00

(52) U.S. Cl. CPC G07C 5/085; B60W 60/001

(57) ABSTRACT

In one aspect, a method and an associated apparatus includes multiple electronic data recorders (EDRs), at least one sensor configured to generate a signal in response to detecting that a sensor measurement exceeds a preset threshold, a cannister including expanding foam, and circuitry in communication with the at least one sensor and the cannister. In response receiving the signal, the circuit is configured to cause the cannister to dispense the expanding foam to envelop at least one of the multiple EDRs. The EDR maybe one of multiple EDRs on a vehicle.

### TECHNICAL FIELD

The field of the disclosure relates generally to autonomous and semi-autonomous vehicles, and more particularly, to a system and associated method of safeguarding event data

### BACKGROUND

An electronic data recorder (EDR) is conventionally a device installed in a motor vehicle to record technical vehicle and occupant information for a period before, during, and after a crash. The data is preserved generally for the purpose of monitoring and assessing vehicle safety system performance. The recorded data may additionally have legal and insurance implications, as well as be used to improve the safety and quality of future travel.

In modern trucks, EDRs are triggered by electronically sensed problems in the engine (i.e., engine faults), or a sudden change in wheel speed. One or more of these conditions may occur because of an accident. True to their function, EDRs should be able to survive extreme high temperatures and external forces. For example, an industry standard requires that EDRs be capable of withstanding temperatures of up to 1000° C. and forces of up to 500 g. Such standards can be hard to meet in practice. Moreover, even with such manufacturing safeguards, EDR data may be lost in some crash scenarios. The costs associated with data loss can be exacerbated in the case of an autonomous vehicle, where EDR storage may include comprehensive performance logs. Such data regularly includes internal system computations, performance metrics, video, light detection and ranging (LiDAR), and radio detection and ranging (RADAR) data streams used for measuring and improving system, as well as to performance to provide context during system triage. There is consequently a need to develop protection for EDR's to ensure the data survives high temperatures and external forces during crashes.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an apparatus includes an electronic data recorder (EDR), at least one sensor configured to generate a signal in response to detecting that a sensor measurement exceeds a preset threshold, a cannister including expanding foam, and circuitry in communication with the at least one sensor and the cannister, wherein in response receiving the signal, the circuit is configured to cause the cannister to dispense the expanding foam to envelop the EDR.

In another aspect, a vehicle includes an EDR of a plurality of EDRs positioned on a vehicle, at least one sensor configured to generate a signal in response to detecting that a sensor measurement exceeds a preset threshold, a cannister including expanding foam, and circuitry comprising at least one processor in communication with the EDR and the cannister, where in response receiving the signal, the circuit is configured to cause the cannister to dispense the expanding foam to envelop the EDR.

In another aspect, a method of protecting an EDR on a vehicle, the method comprising generating at a sensor a signal in response to a sensor measurement exceeding a preset threshold, transmitting the signal to circuitry in communication with the sensor and a dispensing cannister configured to dispense expanding foam (e.g., of a type that may provide thermal insulation); and in response to receiving the signal at the circuitry, initiating dispensing of the expanding foam from the dispensing cannister to envelop an EDR.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of a vehicle such as a truck that includes a fire response system of an exemplary embodiment of the present disclosure.

FIG. 2 is an exemplary schematic block diagram of a computing device for implementation of embodiments of the present disclosure.

FIG. 3 is a block diagram of an autonomous driving system, including an autonomous vehicle that is communicatively coupled with a mission control computing system.

FIG. 4 is a block diagram showing illustrative components of an EDR system juxtaposed with an outline of an autonomous or semi-autonomous vehicle.

FIG. 5 pictorially depicts a fire scenario in which EDR protective features are deployed according to an embodiment of the disclosure.

FIG. 6 is a flow diagram illustrating an embodiment of a method of performing fire control processes in response to detecting a fire or imminent threat of fire as may be performed by the systems of the preceding figures.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

An implementation of the system may protect EDR data by using an encapsulating foam to buffer the EDR from impact and heat. Another or the same implementation may increase the chances of the survivability of the recorded data by including multiple, physically separated EDRs.

More particularly, the implementation may promote EDR data survival by including protection features that include a canister of fire-retardant insulating foam to envelop the EDR in response to a detected impact or fire. Since air circulation may be cut off, an air-cooled EDR implementation may be shut off immediately or soon after deployment of the safety system to prevent overheating. The foam may help protect the mechanical breakup of the EDR, as well as heat damage, until emergency personnel may remove it from the truck. By sufficiently applying insulating foam, the EDR may survive a fire until it is extinguished. In one example, foam may be used that exhibits flame-retardant, non-corrosive, extinguishing features. The foam may also exhibit immediate hardening characteristics after expansion and when exposed to air. A silicon based foam is known to withstand 2100° C. flame for more than 10 minutes without burning. However, other types of fire-retardant foams may be alternatively used.

Another or the same implementation may facilitate EDR data survival by including redundant features. Analysis of empirical data and computer simulations of crash scenarios may determine two or more locations on a semi-truck that are unlikely to both be simultaneously destroyed or seriously damaged. For purposes of illustration, the mount-points of two EDRs may be distanced on opposite ends of the semi-truck. For example, one EDR mounted may be mounted in the front of the cab and another in the rear of the chassis below the trailer. The physical distance separating the mount points may increase the survival chances of at least one of EDRs.

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, or steering wheel positioning, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA. The semi-autonomous vehicle requires a human driver at all times for operating the semi-autonomous vehicle.

A non-autonomous vehicle: A non-autonomous vehicle is a vehicle that is driven by a human driver. A non-autonomous vehicle is neither an autonomous vehicle nor a semi-autonomous vehicle. A non-autonomous vehicle has an autonomy level of level-0 recognized by NHTSA.

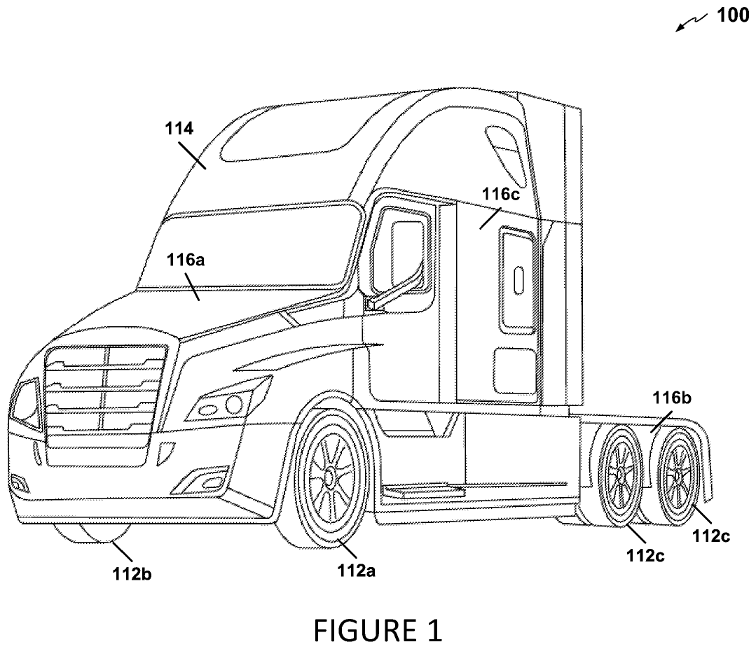

FIG. 1 illustrates a vehicle 100 which may include a truck that may further be conventionally connected to a single or tandem trailer to transport the trailers (not shown) to a desired location. The vehicle 100 includes a cab 114 that can be supported by, and steered in, the required direction by front wheels 112a, 112b, and rear wheels 112c that are partially shown in FIG. 1. Wheels 112a, 112b are positioned by a steering system that includes a steering wheel and a steering column (not shown in FIG. 1). The steering wheel and the steering column may be located in the interior of cab 114. The steering wheel and the steering column, as well as the entire cabin may be omitted in an autonomous vehicle. EDRs 116a-c may record technical vehicle information. The recording may occur continuously, periodically, or in response to an event. While the EDRs 116a-c may be spaced apart from each other for survivability considerations, the orientation and positioning of the EDRs 116a-c in FIG. 1 is arbitrary, and it should be understood they may be positioned at any suitable location in the vehicle 100. The EDRs 116a-c may be recording different things and/or at different tempos or may be recording identical data.

The EDRs 116a-c are included in FIG. 1 for illustrative purposes, and other implementations may include more or fewer EDRs. However, physically separating the EDRs may increase the chances of the survivability of the recorded data. As described herein, EDR data may further be protected by using an encapsulating foam to buffer the EDRs 116a-c from impact and heat.

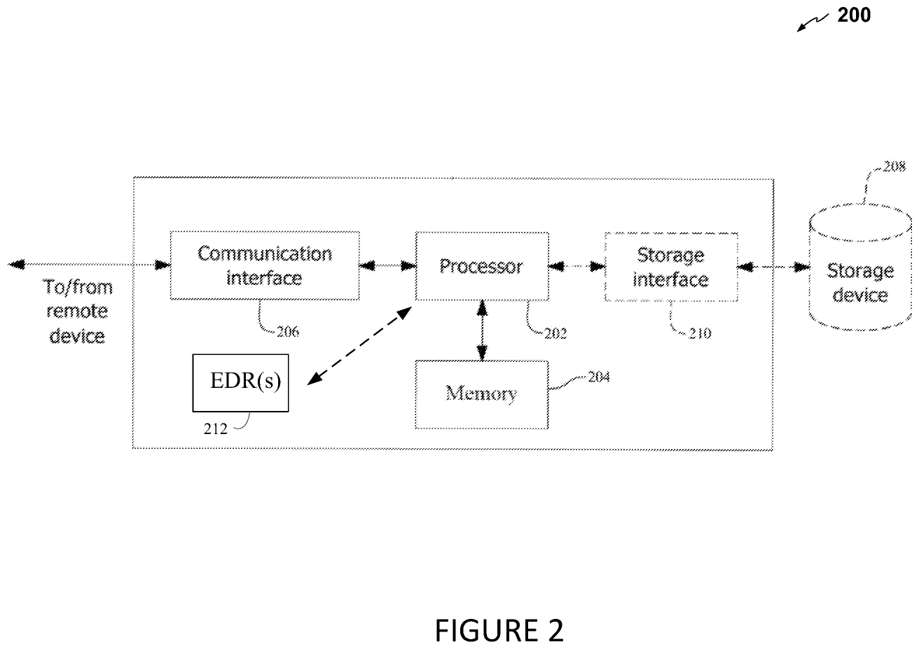

FIG. 2 is an exemplary schematic block diagram of a computing device 200 for implementation of embodiments of the present disclosure. The computing device 200 may include the automated tire monitoring and defect detection system described herein. The computing device 200 may include one or more processing units or processors 202 (e.g., in a multi-core configuration). Processor 202 may be operatively coupled to a communication interface 206 such that the computing device 200 is capable of communicating with another device, such as a remote application server, a user equipment, a mobile device, a smart vehicle, a mission control or a central hub, or another computing device, for example, using wireless communication or data transmission over one or more radio links or digital communication channels using one or more of a Wi-Fi protocol, an RFID protocol, or a Near-Field Communication (NFC) protocol, as one-way communication or two-way communication.

Processor 202 may also be operatively coupled to a storage device 208. Storage device 208 may be any computer-operated hardware suitable for storing or retrieving data, such as, but not limited to, data associated with historic databases. In some embodiments, storage device 208 may be integrated in the computing device 200. For example, the computing device 200 may include one or more hard disk drives as storage device 208.

In other embodiments, storage device 208 may be external to the computing device 200 and may be accessed by a using a storage interface 210. For example, storage device 208 may include a storage area network (SAN), a network attached storage (NAS) system, or multiple storage units such as hard disks or solid-state disks in a redundant array of inexpensive disks (RAID) configuration.

In some embodiments, processor 202 may be operatively coupled to storage device 208 via the storage interface 210. Storage interface 210 may be any component capable of providing processor 202 with access to storage device 208. Storage interface 210 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing processor 202 with access to storage device 208.

The processor 202 may execute computer-executable instructions for implementing aspects of the disclosure. In some embodiments, the processor 202 may be transformed into a special purpose microprocessor by executing computer-executable instructions or by otherwise being programmed. In some embodiments, and by way of a non-limiting example, the memory 204 may include instructions to perform specific operations, as described herein.

In certain implementations, the processor 202 may be in communications with one or more EDRs 212. In such a configuration, the processor 202 may initiate deployment of the foam protective system described herein. For instance, the processor 202 may sense a crash is imminent and deploy the foam system, accordingly. In other implementations, the EDRs 212 are self-contained and have sensing and activation circuitry and processors included within or proximate an EDR housing, or chamber.

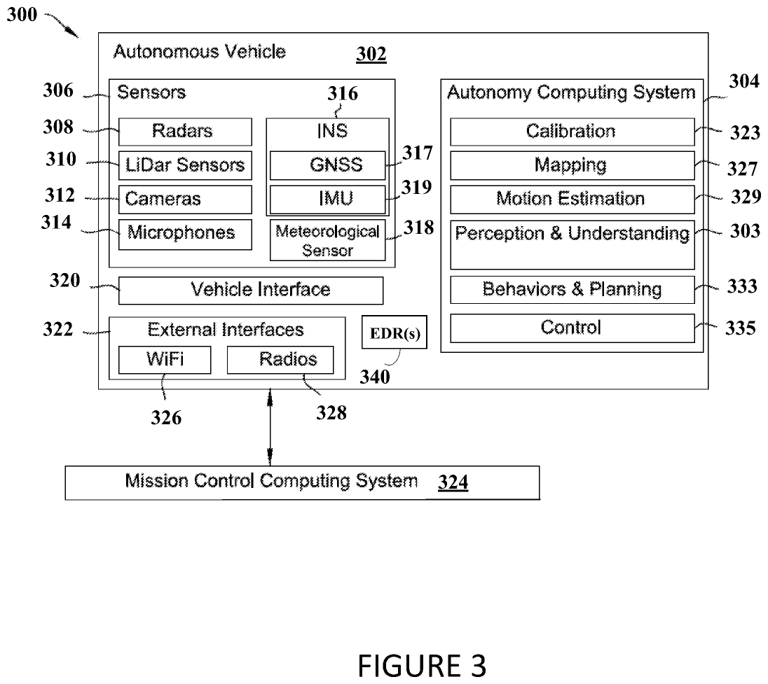

FIG. 3 is a block diagram of an autonomous driving system 300, including an autonomous vehicle 302 that is communicatively coupled with a mission control computing system 324. The vehicle 302 may be similar or the same as described with reference to any of the preceding figures.

In some embodiments, the autonomous vehicle 100 may include sensors 306. Sensors 306 may include radio detection and ranging (RADAR) devices 308, light detection and ranging (LiDAR) sensors 310, cameras 312, and acoustic sensors 314. The sensors 306 may further include an inertial navigation system (INS) 316 configured to determine states such as the location, orientation, and velocity of the autonomous vehicle 100. The INS 316 may include at least one global navigation satellite system (GNSS) receiver 317 configured to provide positioning, navigation, and timing using satellites. The INS 316 may also include at least one inertial measurement unit (IMU) 319 configured to measure motion properties such as the angular velocity, linear acceleration, or orientation (e.g., tipping) of the autonomous vehicle 100. The sensors 306 may further include meteorological sensors 318. Meteorological sensors 318 may include a temperature sensor, a humidity sensor, an anemometer, pitot tubes, a barometer, a precipitation sensor, or a combination thereof. The meteorological sensors 318 are used to acquire meteorological data, such as the humidity, atmospheric pressure, wind, or precipitation, of the ambient environment of autonomous vehicle 302.

The autonomous vehicle 302 may further include a vehicle interface 320, which interfaces with an engine control unit (ECU) (not shown) or a MCU (not shown) of the autonomous vehicle 302 to control the operation of the autonomous vehicle 302 such as acceleration, braking and steering.

The autonomous vehicle 302 may further include external interfaces 322 configured to communicate with external devices or systems such as another vehicle or mission control computing system 324. The external interfaces 322 may include Wi-Fi 326, other radios 328 such as Bluetooth, or other suitable wired or wireless transceivers such as cellular communication devices. Data detected by the sensors 306 may be transmitted to mission control computing system 324 via any of the external interfaces 322.

The autonomous vehicle 302 may further include an autonomy computing system 304. The autonomy computing system 304 may control driving of the autonomous vehicle 100 through the vehicle interface 320. The autonomy computing system 304 may operate the autonomous vehicle 302 to drive the autonomous vehicle from one location to another.

In some embodiments, the autonomy computing system 304 may include modules 323 for performing various functions. Modules 323 may include a calibration module 325, a mapping module 327, a motion estimation module 329, perception and understanding module 303, behaviors and planning module 333, and a control module 335. Modules 323 and submodules may be implemented in dedicated hardware such as, for example, an application specific integrated circuit (ASIC), field programmable gate array (FPGA), or microprocessor, or implemented as executable software modules, or firmware, written to memory and executed on one or more processors onboard the autonomous vehicle 302.

In some embodiments, based on the data collected from the sensors 306, the autonomy computing system 304 and, more specifically, perception and understanding module 303 senses the environment surrounding the autonomous vehicle 302 by gathering and interpreting sensor data. A perception and understanding module 303 interprets the sensed environment by identifying and classifying objects or groups of objects in the environment. For example, perception and understanding module 303 in combination with various sensors 306 (e.g., LiDAR, camera, radar, etc.) of the autonomous vehicle 100 may identify one or more objects (e.g., pedestrians, vehicles, debris, etc.) and features of a roadway (e.g., lane lines) around autonomous vehicle 302, and classify the objects in the road distinctly.

In some embodiments, a method of controlling an autonomous vehicle, such as autonomous vehicle 302, includes collecting perception data representing a perceived environment of autonomous vehicle 302 using the perception and understanding module 303, comparing the perception data collected with digital map data, and modifying operation of the vehicle 302 based on an amount of difference between the perception data and the digital map data. Perception data may include sensor data from sensors 306, such as cameras 312, LiDAR sensors 310, RADAR 308, or from other components such as motion estimation 329 and mapping 327.

The mapping module 327 receives perception data or raw sensor data that can be compared to one or more digital maps stored in mapping module 327 to determine where the autonomous vehicle 302 is in the world or where autonomous vehicle 302 is on the digital map(s). In particular, the mapping module 327 may receive perception data from perception and understanding module 303 or from the various sensors sensing the environment surrounding autonomous vehicle 302 and may correlate features of the sensed environment with details (e.g., digital representations of the features of the sensed environment) on the one or more digital maps. The digital map may have various levels of detail and can be, for example, a raster map, or a vector map. The digital maps may be stored locally on the autonomous vehicle 302 or stored and accessed remotely. In at least one embodiment, the autonomous vehicle 302 deploys with sufficient stored information in one or more digital map files to complete a mission without connection to an external network during the mission.

The behaviors and planning module 333 and the control module 335 plan and implement one or more behavior-based trajectories to operate the autonomous vehicle 302 similarly to a human driver-based operation. The behaviors and planning module 333 and control module 335 use inputs from the perception and understanding module 303 or mapping module 327 and motion estimation 329 to generate trajectories or other planned behaviors. For example, behavior and planning module 333 may generate potential trajectories or actions and select one or more of the trajectories to follow or enact by the controller 335 as the vehicle travels along the road. The trajectories may be generated based on proper (i.e., legal, customary, and safe) interaction with other static and dynamic objects in the environment. Behaviors and planning module 333 may generate local objectives (e.g., following rules or restrictions) such as, for example, lane changes, stopping at stop signs, etc. Additionally, behavior and planning module 333 may be communicatively coupled to, include, or otherwise interact with motion planners, which may generate paths or actions to achieve local objectives. Local objectives may include, for example, reaching a goal location while avoiding obstacle collisions.

Based on the data collected from the sensors 306, the autonomy computing system 304 is configured to perform calibration, analysis, and planning, and control the operation and performance of autonomous vehicle 302. For example, the autonomy computing system 304 is configured to estimate the motion of autonomous vehicle 302, calibrate parameters of the sensors, such as the extrinsic rotations of cameras, LIDAR, RADAR, and IMU, as well as intrinsic parameters, such as lens distortions, in real-time, and provide a map of surroundings of autonomous vehicle 302 or the travel routes of autonomous vehicle 302. The autonomy computing system 304 is configured to analyze the behaviors of autonomous vehicle 302 and generate and adjust the trajectory plans for the autonomous vehicle 302 based on the behaviors computed by the behaviors and planning module 333.

In certain implementations, the autonomy computing system 304 may be in communications with one or more EDRs 340. In such a configuration, the autonomy computing system 304 may initiate deployment of the foam protective system described herein. For instance, the autonomy computing system 304 may sense a crash is imminent and deploy the foam system, accordingly. In other implementations, the EDRs 340 are self-contained and have sensing and activation circuitry and processors included within or proximate an EDR housing of each EDR 340. An autonomous implementation may include a module that does the communication with the sensors and the triggering, or such functions may be done in a separate physical module. In the latter case, the triggering hardware may not be in communication with the system 304 according to an embodiment. Only the recording portion of the EDR may be in communication to do the actual recording.

In some embodiments, the mission control computing system 324 may transmit control commands or data to the autonomous vehicle 100, navigation commands, and travel trajectories to the autonomous vehicle 100, and may receive telematics data from the autonomous vehicle 302 via external interface 322.

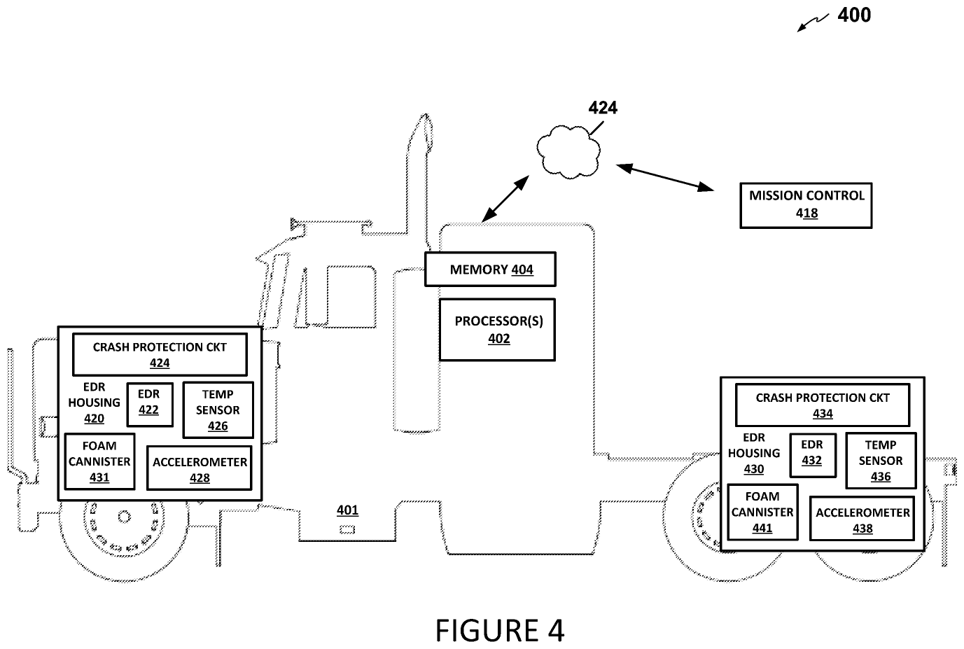

FIG. 4 is a block diagram showing illustrative components of an EDR system 400 juxtaposed with an outline of an autonomous or semi-autonomous vehicle 401. The relative positioning of the modules with respect to the outline are not intended to indicate a physical location, as the underlying hardware, software, and functionality of the modules may be dispersed throughout the vehicle and remotely throughout the system 400. For example, the system 400 includes one or more processors 402 in communication with a memory 404. While the processors 402 and memory 404 are depicted as being included within the autonomous truck, the processors and memory of another implementation, as well as their related functions may be distributed throughout one or more local and remote systems. For instance, a mission control center 418 may communicate instructions and data via a wireless connection 424.

A memory 404 includes instructions (i.e., modules, or algorithms) executable by the processor 402 to operate the autonomous vehicle 401. As illustrated in FIG. 4, the system 400 includes multiple EDRs 422, 432. An implementation of the system 400 may protect EDR data by using an encapsulating foam to buffer the EDRs 422, 432 from impact and heat. The chances of the survivability of the recorded data are enhanced by using more than one EDR and physically separating the EDR units along the vehicle.

The EDR 422 is depicted as being enclosed in a chamber, or housing 420, along with a temperature sensor 426 and an accelerometer 428. Also included is crash protection circuitry 424 configured to receive inputs from the temperature sensor 426 and an accelerometer 428, and in response, to selectively activate a foam cannister 431. The system 400 may facilitate EDR data survival by using the canister 430 of fire-retardant insulating foam to envelop the EDR 422 in response to a detected impact or fire. Since air circulation may be cut off by the foam, an air-cooled EDR implementation may be shut off immediately or soon after deployment of the safety system to prevent overheating. This may be initiated by the crash circuit protection circuit 424. The foam may help protect against damage or the mechanical breakup of the EDR 422, as well as heat damage, until rescue personnel may remove it from the truck 100. With sufficiently insulating foam, the EDR 422 may survive the accelerations of a severe crash, or a fire until it is extinguished. In one example, silicone foam may be used for its flame-retardant, non-corrosive, extinguishing features, which can withstand 2100° C. flame for more than 10 minutes without burning. However, other types of fire-retardant foams may be alternatively used.

Another or the same implementation may facilitate EDR data survival by including redundant EDRs. As shown in FIG. 4, a second EDR 432 may be enclosed in a housing 430, along with a temperature sensor 436 and an accelerometer 438. Also included is crash protection circuitry 434 configured to receive inputs from the temperature sensor 436 and an accelerometer 438, and in response, to selectively activate a foam cannister 441. The positioning of the EDRs 422, 432 may be determined by analysis of empirical data and computer simulations of crash scenarios. For instance, computer modeling may determine two or more locations on a semi-truck that are unlikely to both be simultaneously damaged or destroyed. The physical distance may increase the survival chances of at least one of EDRs 422, 432.

While the activation of the foam deployment over the EDRs 422, 432 in an embodiment of FIG. 4 may be initiated by the processors/circuitry 424, 434 contained within the respective EDR housings 420, 430 described herein, the processors 402 external to the housings 420, 430 may initiate such in other embodiments. More particularly, the processors 402 may receive sensor data indicative of an emergency situation and send signals directly to the foam cannisters 431, 441. Where so configured, such activation may be further initiated by the mission control center 418.

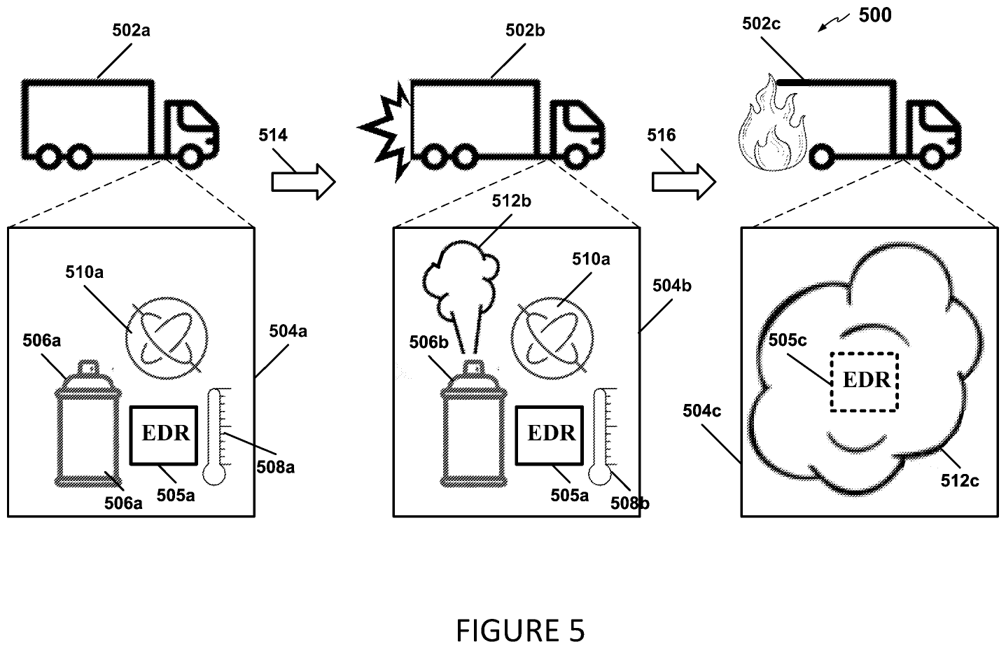

FIG. 5 pictorially depicts a fire scenario in which EDR protective features are deployed according to an embodiment of the disclosure. As illustrated in the drawings, a truck 502a includes an EDR 505a that is included within a housing 504a that also includes a temperature sensor 508a, an accelerometer 510a, rigidly mounted to housing 504a, and a cannister 506a having fire-retardant, solidifying foam. In most embodiment, the temperature sensor may be outside the housing to be triggered based on ambient conditions with a minimum of buffering. The accelerometer may be rigidly mounted to the housing one the inside or outside.

Next is the sequence (delineated by arrow 514), the truck 502b experiences an emergency, such as a crash and/or fire. In response, either or both of the temperature gauge 508b and the accelerometer 510b may sense that a temperature or acceleration, or the direction of gravity with respect to the housing body, indicating tipping of the vehicle, respectively, exceeds preset thresholds. The detection by the temperature gauge 508b or the accelerometer 510b may cause the cannister 506b to initiate dispensing foam 512b.

The next frame of the sequence (following arrow 516) depicts the housing 504c full of protective foam 512c. The foam 512c may envelop and harden around the EDR 505c to preserve the EDR data until it can be recovered from the truck 502c.

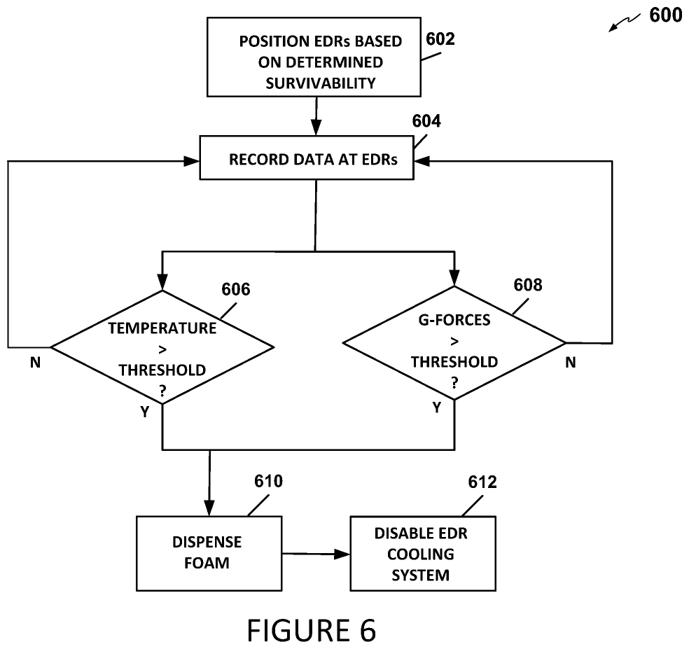

FIG. 6 is a flow diagram of an embodiment of a method 600 of safeguarding against EDR data loss in the case or a wreck or fire. While many of the illustrative processes described herein may apply to a semi-truck and trailer, the embodiments of the underlying method may apply to other types of vehicles, autonomous or otherwise. Moreover, the processes described in the flow diagram may be performed in different sequences in different embodiments of the method 600, which may omit or add other processes from that which is shown in the example of FIG. 6. The method 600 may be performed by any of the systems described in the preceding figures.

Turning more particularly to the drawing, the method 600 may include positioning multiple EDRs on vehicle. For example, the vehicle 401 of FIG. 4 includes multiple EDRs 422, 432. As described herein, the EDRs may be positioned according to computer-implemented analysis of empirical data and computer simulations of crash scenarios. For instance, computer modeling may determine two or more locations on a semi-truck that are unlikely to both be simultaneously destroyed. The physical distance may increase the survival chances of at least one of EDRs.

At 604, data may be recorded at the EDRs. The data recorded at each EDR may be the same, thus providing protection via redundancy.

In the event of a collision, crash, or fire, onboard sensors may generate data that is transformed into a signal to initiate protection processes. For example, a temperature sensor at 426, 436 or 508 may determine 606 that the temperature proximate the EDR has reached a critical threshold. In one example, the threshold could be set at 100° C. In response to the threshold being met at 606, the method 600 at 610 may initiate dispensing foam to encapsulate and protect the EDR from the extreme temperatures and fire.

In another example, the method 600 at 608 may detect that the acceleration resulting from a collision has exceeded a critical threshold. While the threshold may be preset at any practical level that could allow the preservation of EDR data, an illustrative setting may be 60 g. In response to the threshold being met at 608, the method 600 at 610 may initiate dispensing the foam to encapsulate and protect the EDR from potentially damaging forces.

The foam encapsulating the EDR at 610 may cut of air circulation, so an air-cooled EDR implementation may be shut off at 612 immediately or soon after deployment of the safety system to prevent overheating.

In a crash, even if the acceleration gets very severe, the threshold may be low enough that the foam has taken effect before the effects of the crash. For example, if a wall is hit, the acceleration might hit 100 g in about 10 ms, and may rise even further, but not before the protection mechanism has been triggered.

Some embodiments involve the use of one or more electronic processing or computing devices. As used herein, the terms “processor” and “computer” and related terms, e.g., “processing device,” “computing device,” and “controller” are not limited to just those integrated circuits referred to in the art as a computer, but broadly refers to a processors, a processing device, a controller, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms such as processor, processing device, and related terms.

In the embodiments described herein, memory may include, but is not limited to, a non-transitory computer-readable medium, such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. An apparatus comprising:
an electronic data recorder (EDR);
at least one sensor configured to generate a signal in response to detecting that a sensor measurement exceeds a preset threshold;
a cannister including expanding foam; and
circuitry in communication with the at least one sensor and the cannister, wherein in response receiving the signal, the circuit is configured to cause the cannister to dispense the expanding foam to envelop the EDR.

2. The apparatus of claim 1, wherein the at least one sensor is a temperature sensor.

3. The apparatus of claim 1, wherein the at least one sensor is configured to acceleration.

4. The apparatus of claim 1, wherein the at least one sensor is an accelerometer.

5. The apparatus of claim 1, wherein the at least one sensor includes a sensor to detect acceleration and a temperature sensor.

6. The apparatus of claim 1, further comprising a housing, wherein the housing includes the EDR and the cannister.

7. The apparatus of claim 6, wherein the housing further includes the at least one sensor.

8. The apparatus of claim 1, wherein the circuitry is further configured to disable a cooling system for cooling the EDR in response to the signal.

9. The apparatus of claim 1, wherein the circuitry includes one or more processors in communication with a plurality of EDRs that includes the EDR.

10. The apparatus of claim 9, wherein the one or more processors are configured to receive the signal.

11. The apparatus of claim 9, wherein the one or more processors are further configured to update the EDR data at each of the plurality of EDRs.

12. A vehicle comprising:
an electronic data recorders (EDRs) of a plurality of EDRs positioned on the vehicle;
at least one sensor configured to generate a signal in response to detecting that a sensor measurement exceeds a preset threshold;
a cannister including expanding foam; and
circuitry comprising at least one processor in communication with the EDR and the cannister, wherein in response receiving the signal, the circuit is configured to cause the cannister to dispense the expanding foam to envelop the EDR.

13. The vehicle of claim 12, wherein the at least one processor is in communication with the plurality of EDRs.

14. A method of protecting an electronic data recorder (EDR) on a vehicle, the method comprising:
generating at a sensor a signal in response to a sensor measurement exceeding a preset threshold;
transmitting the signal to circuitry in communication with the sensor and a dispensing cannister configured to dispense expanding foam; and
in response to receiving the signal at the circuitry, initiating a protection mechanism for an EDR.

15. The method of claim 14, wherein generating the signal at the sensor further includes generating the signal at a temperature sensor.

16. The method of claim 14, wherein generating the signal at the sensor further includes generating the signal at a sensor configured to sense acceleration.

17. The method of claim 14, wherein generating the signal at the sensor further includes generating the signal at an accelerometer.

18. The method of claim 14, wherein the protection mechanism includes at least one of dispensing foam and disabling a cooling system.

19. The method of claim 18, further comprising positioning at least one of the circuitry and the sensor within the housing.

20. The method of claim 14, further comprising disabling a cooling system for cooling the EDR in response to the signal.
